(19) United States
(12) Patent Application Publication
(10) Pub. No.: US 2026/0200236 A1
(43) Pub. Date: Jul. 16, 2026

(54) Printer

(71) Applicant: Videojet Technologies Inc., Wood Dale, IL (US)

(72) Inventors: Robert Smith, Cambridgeshire (GB); Steven John Buckby, Nottingham (GB); William Caton, Cambridge (GB); Patryk Gawlinski, Cambridge (GB); Aaron Lynn Neil Kelly, Cambridge (GB); Nigel Edward Sherman, Cambridgeshire (GB); Michael Jeffrey Stamp, Cambridgeshire (GB); Salhadin Omer, Cambridgeshire (GB); Matthew William Stephen Burrows, Cambridge (GB); Sylvain Bruno Jamais, Cambridge (GB); Rishi Dhanvantray Jobanputra, Cambridge (GB); Joshua Aleksander de Gromoboy Dabrowicki, Cambridge (GB); Richard Francis Day, Cambridge (GB)

(21) Appl. No.: 19/138,030

(22) PCT Filed: Dec. 13, 2023
(86) PCT No.: PCT/GB2023/053219

§ 371 Date: Jun. 11, 2025

(30) Foreign Application Priority Data
Dec. 19, 2022 (GB) 2219188.6
Dec. 19, 2022 (GB) 2219193.6

(51) Int. Cl. B41J 2/185; B41J 2/02; B41J 2/085; B41J 2/175; B41J 11/00; B41J 25/316; B41J 25/34

(52) U.S. Cl. CPC B41J 2/185; B41J 2/02; B41J 2/085; B41J 2/17596; B41J 11/008; B41J 25/316; B41J 25/34; B41J 2002/1853

(57) ABSTRACT

There is provided a continuous inkjet printer for printing onto an external substrate that moves past the printer. The printer comprising: a print head. The print head comprising: a nozzle for generating and ejecting a stream of ink droplets for printing; at least one electrode for guiding the stream of ink droplets; and a gutter for receiving droplets of ink which are not used for printing. The printer comprising an ink system for storing ink and supplying ink to the print head, the ink system comprising a gutter pump in fluid communication with the gutter. The print head is fluidly coupled to the ink system via a plurality of fluid conduits, the plurality of conduits comprising a main return line; and a portion of the main return line which extends between the gutter and the gutter pump has a length of no more than 1 metre.

The present invention relates to a continuous inkjet (CIJ) printer, and associated methods of using and controlling the same.

In inkjet printing systems, the print is made up of individual droplets of ink generated at a nozzle and propelled towards a substrate. There are two principal systems: droplet on demand, where ink droplets for printing are generated as and when required; and continuous inkjet (CIJ) printing, in which droplets are continuously produced and only selected ones are directed towards the substrate, the others being recirculated to an ink system.

CIJ printers supply pressurised ink to a print head droplet generator where a continuous stream of ink emanating from a nozzle is broken up into individual regular droplets by, for example, an oscillating piezoelectric element. The droplets are directed past a charge electrode, where they are selectively and separately given a predetermined charge, before passing through a transverse electric field provided across a pair of deflection plates, the pair comprising a high voltage (or extra high tension (EHT)) plate and a zero or negative voltage plate (the ‘ground’ plate). Each charged droplet is deflected by the field by an amount that is dependent on its charge magnitude before impinging on the substrate, whereas the uncharged droplets proceed without deflection and are collected at a gutter from where they are recirculated to the ink system. The charged droplets bypass the gutter and hit the substrate at a position determined by the charge on the droplet and the position of the substrate relative to the print head. Typically, the substrate is moved relative to the print head in one direction and the droplets are deflected in a direction generally perpendicular thereto, although the deflection plates may be oriented at an inclination to the perpendicular to compensate for the speed of the substrate (the movement of the substrate relative to the print head between droplets arriving means that a line of droplets would otherwise not quite extend perpendicularly to the direction of movement of the substrate). The various components of the print head are typically contained within a cover tube or print head casing.

In CIJ printing, a character is printed from a matrix comprising a regular array of potential droplet positions. Each matrix comprises a plurality of columns (strokes), each being defined by a line comprising a plurality of potential droplet positions (e.g. seven) determined by the charge applied to the droplets. Thus, each usable droplet is charged according to its intended position in the stroke. If a particular droplet is not to be used then the droplet is not charged and it is captured at the gutter for recirculation. This cycle repeats for all strokes in a matrix and then starts again for the next character matrix.

Ink is delivered under pressure to the print head by an ink system that is generally housed within a sealed compartment of a cabinet that includes a separate compartment for control circuitry and a user interface panel. The ink system includes a main pump that draws the ink from a reservoir or tank (often referred to as a mixer tank) via a filter and delivers it under pressure to the print head. As ink is consumed, the reservoir is refilled as necessary from a replaceable ink cartridge that is releasably connected to the reservoir by a supply conduit. The ink is fed from the reservoir via a flexible delivery conduit to the print head. The unused ink droplets captured by the gutter are recirculated to the reservoir via a return conduit by a pump. The flow of ink in each of the conduits is generally controlled by solenoid valves and/or other like components.

As the ink circulates through the system, there is a tendency for it to thicken because of solvent evaporation, particularly in relation to the recirculated ink that has been exposed to air in its passage between the nozzle and the gutter. In order to compensate for this, “make-up” solvent is added to the ink as required from a replaceable solvent cartridge to maintain the ink viscosity within desired limits. The ink and solvent cartridges are filled with a predetermined quantity of fluid and generally releasably connected to the reservoir, or mixer tank, of the ink supply system so that the reservoir can be intermittently topped-up by drawing ink and/or solvent from the cartridges as required.

CIJ printers generally operate in high throughput environments for which the printers, and inks, need to be able to keep up with high production line speeds, fast drying time requirements and virtually non-stop production. This generally requires larger containers for storing and holding the ink and solvent (e.g. cartridges and mixer tank), which take up space within the system, and results in high volumes of ink circulating through the printer. For example, the main pump of the ink supply system may typically circulate around 0.5 litres of ink per minute, with only around 2-3 millilitres per minute of ink being ejected from the print head for printing during this time. The main pump is therefore generally fairly large and space consuming, and operation of the pump generally results in significant heat generation. To manage this, the printer generally requires fans to prevent the printer and/or ink supply system from overheating, the fans therefore also taking up space within the printer. As such, the printer, in particular the printer cabinet, tend to be fairly large.

As indicated above, the ink supply system is generally housed within a cabinet and so the cabinet needs to have a size large enough to accommodate the ink supply system and any associated elements. The print head is typically disposed outside of the cabinet. Ink is delivered from the ink supply system, to the print head, and recycled back to the ink supply system via flexible tubes which are bundled together with other fluid tubes and electrical wires into, what is described in the field as, an umbilical. As such, the ink supply system and cabinet are connected to the print head via the umbilical cable, which is typically around 2 to 8 metres long.

As mentioned above, the unused ink drops captured by the gutter in the print head are recirculated to the mixer tank in the ink supply system via a return conduit by a pump. The pump may draw air, ink and/or solvent into the gutter and back to the ink supply system via the return conduit. Given the length of the umbilical cable, and therefore the length of the return path including the return conduit, this typically results in a significant air flow through the system. Such significant air flow can result in solvent vapour loss, meaning that additional ‘make-up’ solvent may be required to maintain the ink viscosity within desired limits to account for this loss.

Having the print head connected to the cabinet via the umbilical means that the printer is generally provided with two mounts for printing: one to support the cabinet and one to support the print head. This arrangement is desirable for at least two reasons. A first is that the print head needs to be supported adjacent the production line for printing onto the substrate. Therefore, having the fairly compact print head somewhat separated from the cabinet avoids the need for adequate space to be provided on the production line for the larger and bulkier cabinet. The print head can be positioned adjacent the production line, and the cabinet can be distanced from the production line. A second is that the ink supply system, and therefore cabinet, may need to be placed in a specific orientation in order for the printer to be able to print. Therefore, having the print head somewhat separated from the cabinet via the umbilical cable means that the print head can be positioned in different positions and orientations (i.e. the position of the print head be at least partially decoupled from that of the cabinet) to allow for more flexibility in printer operation and printing orientation.

There exists a need to provide an alternative continuous inkjet (CIJ) printer that overcomes one or more of the disadvantages of known systems, whether mentioned in this document or otherwise.

According to a first aspect there is provided a continuous inkjet printer for printing onto an external substrate that moves past the printer, the printer comprising: a print head, the print head comprising: a nozzle for generating and ejecting a stream of ink droplets for printing; at least one electrode for guiding the stream of ink droplets; and a gutter for receiving droplets of ink which are not used for printing; and an ink system for storing ink and supplying ink to the print head, the ink system comprising a gutter pump in fluid communication with the gutter; wherein: the print head is fluidly coupled to the ink system via a plurality of fluid conduits, the plurality of conduits comprising a main return line; and a portion of the main return line which extends between the gutter and the gutter pump has a length of no more than 1 metre.

The external substrate may form part of an article (e.g. fast moving consumer goods) onto which printing occurs. The external substrate may move past the printer by way of being provided on a printing line.

The nozzle may otherwise be described as an aperture of a droplet generator, or a jewel. At least some of the ink droplets of the stream of ink droplets may be deflected in operation to apply a printed pattern to the external substrate. The stream of ink droplets generated by the nozzle may be generated by breaking up a continuous stream of ink using, for example, an oscillating piezoelectric element. Droplets may then be directed past a charge electrode where they are given an electric charge, and subsequently guided by a further electrode to direct the now-charged droplet as needed. The at least one electrode for guiding the stream of ink droplets may comprise a zero or negative voltage plate (e.g. the ground plate) and a high voltage (extra high tension (EHT)) plate. A (transverse) electric field is generated across the plates and a charged droplet is deflected by the field by an amount dependent upon the charge and the electric field.

The ink system may comprise a number of components including, but not limited to, a mixer tank, a plurality of pumps (of which the gutter pump may be one), a cartridge, a plurality of filters, a plurality of valves and, optionally, one or more (e.g. an array of) quick disconnect connectors. The ink system may be described as being a closed system in which ink and solvent are received by way of a cartridge, and an appropriate mixture is prepared in the mixer tank ready for printing. Ink is supplied from the mixer tank to the print head.

The plurality of fluid conduits by which the print head is fluidly coupled to the ink system may comprise a main supply line and the main return line. The main supply line may be described as extending from at least an ink pump to the nozzle. More specifically, the main supply line may extend from the mixer tank to the nozzle. The main return line extends from at least the gutter to the gutter pump, and more preferably from the gutter to the mixer tank. The print head may thus be described as being fluidly coupled to the mixer tank, ink pump and gutter pump. A plurality of electrical wires may extend between the ink system and the print head.

The portion of the main return line which extends between the gutter and the gutter pump may otherwise be described as a conduit which extends from the gutter to the gutter pump. The portion of the main return line which extends between the gutter and the gutter pump may be described as a first portion of the main return line. The main return line may extend beyond the gutter pump to place the gutter pump in fluid communication with a mixer tank. That is to say, the main return line may extend from the gutter to the mixer tank. Said extension may be referred to as a second portion of the main return line. The portion of the main return line which extends between the gutter pump and the gutter having a length of no more than 1 metre may be described as the gutter and gutter pump being fluidly connected to one another by a conduit having a length of 1 metre or less. One or more valves, quick-disconnect connectors or other components may be provided along the portion of the conduit. The gutter pump is preferably located in a printer body.

The portion of the main return line which extends between the gutter pump and the gutter having a length of no more than 1 metre offers a number of advantages: reduced gutter flow due to the comparatively short length of fluid conduit; lower solvent consumption; and less conduit to flush out during flushing cycles.

The entire main return line, which extends between the gutter and a mixer tank, may be at most 1 metre in length.

Each of the plurality of fluid conduits which extend between the ink system and the print head may be at most 1 metre in length.

By limiting the length of the fluid conduits, which fluidly couple the print head to the ink system, to no more than around 1 metre in length: i) the volume of ink contained in the main supply line is reduced, reducing the volume of ink which need be flushed during flushing cycles (e.g. priming the printer at start-up can occur more swiftly); ii) the pumping work required from the pump(s) is reduced, resulting in reduced heat generation in the system, a reduction in the size of various components in the system (e.g. the pump(s)) and the overall printer itself), and reduced power consumption; iii) less air is drawn into the ink system, reducing the amount of venting required, which reduces the amount of solvent vapour vented from the system (thus reducing emissions and smell) and so the consumption of make-up solvent is reduced; and iv) ink life in the ink system is improved. Ink life in the ink system is improved at least by virtue of reducing airflow and temperature (by reducing pumping power) in the ink system. This reduces the risk of ink becoming oxidised, which can otherwise occur in the presence of air and heat. A potential loss of conductance of the ink, and chemical degradation of the ink, is also mitigated.

The portion of the main return line which extends between the gutter and the gutter pump may have a length of no more than 500 millimetres. The portion of the main return line which extends between the gutter and the gutter pump may have a length of at least 100 millimetres.

A flush volume of the printer may be no more than 4 ml.

The flush volume is defined by the combined volume of the portions of conduit and nozzle that extend between a feed valve and the nozzle, and a side port and a purge valve. The flush volume is the volume of line needing to be flushed with solvent when printing stops (e.g. when the jet of ink/solvent mixture through the main supply line is stopped). The flush volume refers to the volume of the conduits and excludes, for example, any ink pump, pressure transducer, damper, filters, valves and any quick disconnect connectors (if applicable).

By limiting the flush volume, flushing uses a lower volume of solvent. Flushing can therefore be carried out faster, and using less solvent, than would otherwise be the case.

The printer may comprise a printer body which houses the ink system components including an ink tank and an ink pump.

The printer body may otherwise be described as a printer cabinet. The printer body is a housing in which the majority of the components of the printer are contained. In particular, the printer body may be described as housing various components of a fluid circuit, many of which form part of the ink system of the printer. As well as the ink tank and ink pump, the ink system may further comprise ink and solvent refill pumps, ink and solvent supply lines, a gutter pump, a mixer tank and a variety of other valves and filters. The ink system may be configured to control the consistency of an ink and solvent mixture in the mixer tank, ready for printing.

The printer body may comprise a graphical user interface, such as a screen, which receives signals from an operator in order to control the printer.

The printer may further comprise an umbilical, the umbilical coupling the print head to the printer body and housing the plurality of fluid conduits, wherein a length of the umbilical may be no more than 1 metre.

The length of the umbilical may be no more than 500 millimetres.

The length of the umbilical may be at least 100 millimetres.

The umbilical may be described as a flexible conduit which contains a plurality of other lines and/or conduits. The umbilical may house the plurality of fluid conduits which couple the print head to the ink system. A plurality of electrical wires may also extend through the umbilical.

Advantageously, the umbilical means that the print head can be manipulated and aligned correctly, relative to an external substrate to be printed, at a convenient distance from the printer body. Where the length of the umbilical is no more than 1 metre, the print head position can still be adjusted without incurring the disadvantages associated with lengthy umbilicals as known in the prior art. Such disadvantages include increased pumping requirement, increased heat generation, and increased requirement to refill solvent, among others.

The print head may be pivotally connected to the printer body and may be rotatable about a print head rotation axis.

The print head may be directly connected to the printer body. Alternatively, the print head may be indirectly connected to the printer body via one or more interposing components, such as a print head support arm (e.g. a tiltable portion, or non-tiltable portion, of a print head support arm). The print head may be pivotally connected to the printer body by a rotatable coupling. The rotatable coupling may be configured to permit the print head to rotate relative to the printer body about the print head rotation axis. The print head rotation axis may be substantially perpendicular to an ink ejection axis defined by an ink ejection aperture of the print head. Described another way, the print head being rotatable about the print head rotation axis adjusts the direction of the print head (e.g. ink ejection axis) with respect to the printer body, rather than rotating the print head about a fixed mount to simply change the orientation of the ink pattern.

The print head may be connected to the printer body by the umbilical and a rotatable coupling.

The rotatable coupling may interpose the printer body and the umbilical. The print head may be directly coupled to the umbilical. The rotatable coupling may facilitate directional adjustment of the umbilical with respect to the printer body.

The print head may be supported by the printer body during operation.

Described another way, the printer body supports the print head (either directly or indirectly). This avoids the need for an additional print head clamp or support structure which may otherwise be needed. The printer body may support the print head and negate the need for an umbilical.

Advantageously, by supporting the print head directly from the printer body, it is possible for one person to easily move the entire printer, since the overall mass can be reduced, and there is no trailing umbilical and print head. This allows easier movement from one production line to another or replacement due to failure. Furthermore, the umbilical otherwise comprises various fluid conduits and wires running therethrough, as well as a surrounding shielding, which can be resistive to manipulation/flexing.

The print head rotation axis may be substantially horizontal during printing operations. The print head may have a deployed configuration for printing, and a stowed configuration for storage.

The printer body may comprise a print head recess for receiving the print head in the stowed configuration.

The print head may be connected to a print head support arm, the print head support arm being pivotally coupled to the printer body.

The print head may be removable from the print head support arm.

The continuous inkjet printer may further comprise a position detector. The position detector may be an accelerometer.

According to a second aspect, there is provided a continuous inkjet printer for printing onto an external substrate that moves past the printer, the printer comprising: a print head, the print head comprising: a nozzle for generating and ejecting a stream of ink droplets for printing; at least one electrode for guiding the stream of ink droplets; and a gutter for receiving droplets of ink which are not used for printing; and an ink system for storing ink and supplying ink to the print head; and a printer body which houses the ink system; wherein the print head is pivotally connected to the printer body by a rotatable coupling, the rotatable coupling being configured to permit the print head to rotate relative to the printer body about a print head rotation axis.

The external substrate may form part of an article (e.g. fast moving consumer goods) onto which printing occurs. The external substrate may move past the printer by way of being provided on a printing line.

The nozzle may otherwise be described as an aperture of a droplet generator, or a jewel. At least some of the ink droplets of the stream of ink droplets may be deflected in operation to apply a printed pattern to the external substrate. The stream of ink droplets generated by the nozzle may be generated by breaking up a continuous stream of ink using, for example, an oscillating piezoelectric element. Droplets may then be directed past a charge electrode where they are given an electric charge, and subsequently guided by a further electrode to direct the now-charged droplet as needed. The at least one electrode for guiding the stream of ink droplets may comprise a zero or negative voltage plate (e.g. the ground plate) and a high voltage (extra high tension (EHT)) plate. A (transverse) electric field is generated across the plates and a charged droplet is deflected by the field by an amount dependent upon the charge and the electric field.

The ink system may comprise a number of components including, but not limited to, a mixer tank, a plurality of pumps (of which the gutter pump may be one), a cartridge, a plurality of filters, a plurality of valves and, optionally, one or more (e.g. an array of) quick disconnect connectors. The ink system may be described as being a closed system in which ink and solvent are received by way of a cartridge, and an appropriate mixture is prepared in the mixer tank ready for printing. Ink is supplied from the mixer tank to the print head.

The print head may be directly connected to the printer body. Alternatively, the print head may be indirectly connected to the printer body via one or more interposing components, such as a print head support arm (e.g. a tiltable portion, or non-tiltable portion, of a print head support arm).

By providing a rotatable coupling between the print head and the printer, the print head can be rotated relative to the printer body to ensure printing occurs at the correct location on a substrate. Furthermore, the rotatable coupling avoids the need for a separate print head support, whilst still allowing convenient adjustment of the print head position (by rotating the print head).

A further advantage of the print head being pivotally connected to the printer body is that fluid conduits which couple the print head to the ink system can be made comparatively shorter (e.g. no more than 1 metre in length). The various advantages associated with these comparatively short fluid conduit lengths can therefore be obtained.

A higher washdown print head is also provided having: reduced gutter flow; lower solvent consumption; and less conduit to flush out during flushing cycles.

The print head may have a deployed configuration for printing, and a stowed configuration for storage.

The printer may have a plurality of different deployed configurations. For example, the print head may be positioned to face in the direction of either of first and second major surfaces of the printer body, or in a different direction, when in a deployed configuration.

The deployed configuration may otherwise be described as a print-ready configuration. A stowed configuration refers to a configuration in which the printer is not print ready, and is instead of use for when the printer is in transit (e.g. protecting the print head).

Advantageously, being able to transition the print head between configurations provides improved flexibility in aligning the print head with an external substrate to be printed upon, and also provides the functionality that the print head can be better protected in transit. The risk of damage occurring to the print head can therefore be reduced when the printer is not actively required for printing.

The print head may comprise an ink ejection aperture, wherein ink droplets that are not captured by the gutter are ejected through the ink ejection aperture.

The ink ejection aperture may be described as an opening through which a stream of droplets, which are to be used for printing, are directed. The droplets may be described as charged and deflected droplets. Ink droplets that are captured by the gutter may be described as droplets not used for printing.

In the stowed configuration the print head may be orientable such that the ink ejection aperture faces towards the printer body.

The ink ejection aperture may face towards the printer body such that if ink were to be ejected there is a lower risk that the ink be ejected onto a substrate (e.g. an article) or onto a production line. By having the ink ejection aperture face towards the printer body, the print head, specifically the ink ejection aperture thereof, is better protected against the ingress of debris.

In the stowed configuration, the print head may be sealed by engagement with a face of the printer body. That is to say, a sealing face of a recess of the printer body may interfere/contact an outer face of the print head to seal the ink ejection aperture.

In the deployed configuration the print head may be orientable such that the ink ejection aperture faces away from the printer body.

The ink ejection aperture may face away from the printer body by being directed in the same direction as first or second major surfaces of the printer body or in a different direction (e.g. being directed away from a base of the printer body). The deployed configuration may be described as a configuration in which the ink ejection aperture is directed such that ejected ink does not impinge on the printer body.

The printer body may comprise a print head recess for receiving the print head in the stowed configuration.

The print head recess may be said to permit rotation of the print head between the stowed configuration and the deployed configuration. The print head may be nestable within the print head recess. The print head recess may be described as a cut-out in an overall major footprint of the printer body.

Advantageously, in the stowed configuration the print head support arm is receivable in the print head recess to reduce the risk of damage to the print head when the printer is in transit.

The print head may be connected to a print head support arm, the print head support arm being pivotally coupled to the printer body.

The print head may be directly connected to the print head support arm (e.g. a tiltable portion thereof). The print head support arm (e.g. a non-tiltable portion thereof) may be directly (pivotally) connected to the printer body.

The print head may be removable from the print head support arm.

The print head may be removable from the print head support arm by way of a snap-fit coupling or other detachable coupling. The print head may be described as removably engageable with the print head support arm.

Advantageously, the print head being removable from the print head support arm facilities the swapping out of the print head where needed for maintenance or servicing.

The continuous inkjet printer may further comprise a position detector.

The position detector may be a rotational position detector. The position detector may be an accelerometer. The print head and/or the print head support arm may comprise a position detector.

The printer may comprise a plurality of position detectors. One or more position detectors may be configured to detect one or more of: a rotational position of the print head with respect to the printer body, the orientation of the printer body in use, and a tilt angle of the print head with respect to the printer body. The one or more position detectors may be operatively connected to a controller.

Advantageously, the incorporation of a position detector provides useful information regarding the status and position of the printer or one or more sub-components thereof (e.g. the print head). The one or more position detectors may also be configured to detect whether the printer is in a deployed or a stowed configuration, and furthermore which of a plurality of different deployed configurations the printer is in.

The rotatable coupling may comprise the position detector.

The position detector may be a rotary encoder.

The print head may be rotatable though around 270 degrees about the print head rotation axis.

The position detector may be an accelerometer.

An accelerometer may be incorporated in one or more of the print head, the print head support arm (e.g. a tiltable portion and/or a non-tiltable portion, where applicable), the printer body, and the rotatable coupling. The accelerometer may be operatively connected to a controller.

Advantageously, the accelerometer may be configured to detect the orientation of the overall printer. For example, the accelerometer may be configured to detect whether the printer is supported on either one of first and second major surfaces of the printer body, or another surface.

The print head may be tiltable about a print head tilt axis, the print head tilt axis may be substantially orthogonal to the print head rotation axis.

The print head may specifically be tiltable relative to a non-tiltable portion of a print head support arm. The print head may be coupled (e.g. removable engageable) to a tilting portion of the print head support arm such that both the print head and the tilting portion of the print head support arm tilt (e.g. are tiltable) with respect to the non-tilting portion of the print head support arm.

Advantageously, being able to tilt the print head relative to the printer body can compensate for a slanting of the printed pattern than may otherwise result from the external substrate moving past the print head at speed. The tiltable nature of the print head therefore facilitates printing onto higher speed print lines or onto sloping lines where the characters could otherwise be distorted.

The print head tilt axis may be parallel to an ink ejection axis.

Advantageously, tilting the print head in this way allows the print angle on a substrate to be changed.

The print head may be tiltable by around +/−20 degrees.

The print head being tiltable facilitates printing onto high-speed lines (to avoid sloping characters) or onto sloping lines.

The print head rotation axis may be substantially horizontal during printing operations. The print head may be fluidly coupled to the ink system via a plurality of fluid conduits, the plurality of conduits may comprise a main return line; and a portion of the main return line which extends between the gutter and a gutter pump may have a length of no more than 1 metre.

The plurality of fluid conduits by which the print head is fluidly coupled to the ink system may comprise a main supply line and the main return line. The main supply line may be described as extending from at least an ink pump to a nozzle. More specifically, the main supply line may extend from a mixer tank to the nozzle. The main return line extends from at least the gutter to the gutter pump, and more preferably from the gutter to the mixer tank. The print head may thus be described as being fluidly coupled to the mixer tank, ink pump and gutter pump.

The ink system may comprise the gutter pump. The gutter pump is in fluid communication with the gutter The portion of the main return line which extends between the gutter and the gutter pump may otherwise be described as a conduit which extends from the gutter to the gutter pump. The portion of the main return line which extends between the gutter and the gutter pump may be described as a first portion of the main return line. The main return line may extend beyond the gutter pump to place the gutter pump in fluid communication with a mixer tank. That is to say, the main return line may extend from the gutter to the mixer tank. Said extension may be referred to as a second portion of the main return line. The portion of the main return line which extends between the gutter pump and the gutter having a length of no more than 1 metre may be described as the gutter and gutter pump being fluidly connected to one another by a conduit having a length of 1 metre or less. One or more valves, quick-disconnect connectors or other components may be provided along the portion of the conduit.

The portion of the main return line which extends between the gutter pump and the gutter having a length of no more than 1 metre offers a number of advantages: reduced gutter flow due to the comparatively short length of fluid conduit; lower solvent consumption; and less conduit to flush out during flushing cycles.

Each of the plurality of fluid conduits (e.g. the main supply line and main return line) which extend between the ink system and the print head may be at most 1 metre in length. A plurality of electrical wires may extend between the ink system and the print head.

A flush volume of the printer may be no more than 4 ml.

The flush volume is defined by the combined volume of the portions of conduit and nozzle that extend between a feed valve and the nozzle, and a side port and a purge valve. The flush volume is the volume of line needing to be flushed with solvent when printing stops (e.g. when the jet of ink/solvent mixture through the main supply line is stopped). The flush volume refers to the volume of the conduits and excludes, for example, any ink pump, pressure transducer, damper, filters, valves and any quick disconnect connectors (if applicable).

By limiting the flush volume, flushing uses a lower volume of solvent. Flushing can therefore be carried out faster, and using less solvent, than would otherwise be the case.

It will be appreciated that features of the first aspect may be combined with features of the second aspect, and features of the second aspect may be combined with features of the first aspect.

According to a third aspect, there is provided a method of using a continuous inkjet printer comprising: positioning a printer body with respect to a target print location; rotating a print head relative to the printer body, about a print head rotation axis, to align an ink ejection aperture of the print head with the target print location.

The target print location may be an external substrate.

Advantageously, rotating the print head relative to the printer body may alleviate the need for a separate print head bracket.

Rotating the print head relative to the printer body may transition the printer from a stowed configuration, in which the print head may be received in a print head recess, to a deployed configuration in which the ink ejection aperture may face away from the printer body.

After printing, the print head may be rotated relative to the printer body to transition the printer to the stowed configuration in which the print head may be received in the print head recess.

According to a fourth aspect, there is provided a method of controlling a continuous inkjet printer comprising: generating data, using a position detector, indicating a position of the print head; comparing the data indicating the position of the print head with reference data indicating a reference position of the print head; and generating an output indicative of a difference between the position and the reference position.

The method may be described as a method of returning a printer to a pre-cleaning configuration.

The method is advantageous because the printer can effectively recall a previous printing configuration, after the printer has been cleaned (and so the print head adjusted relative to the printer body), so an operator can readily return the printer to the printing configuration.

The method of claim may further comprise: adjusting a position of the print head, based upon the output; and generating new data, using the position detector, indicating an adjusted position of the print head; comparing the data indicating the adjusted position of the print head with reference data indicating the reference position of the print head; and generating an output indicative of a difference between the position and the reference position.

Features of the first aspect may be combined with features of the second to fourth aspects. Features of the second aspect may be combined with features of the first, third, or fourth aspects. Features of the third aspect may be combined with features of the first, second, or fourth aspects. Features of the fourth aspect may be combined with features of the first to third aspects

Feature(s) of one aspect or embodiment or example as described and/or shown herein may be provided in conjunction with any other aspects or embodiments or example, or features thereof, as described and/or shown herein, as appropriate and applicable. Specific embodiments of the present invention will now be described, by way of example only, with reference to the accompanying drawings in which:

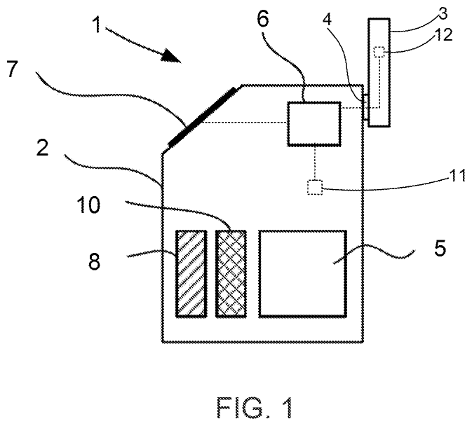

FIG. 1 is a schematic illustration of a continuous inkjet (CIJ) printer in accordance with an embodiment of the invention;

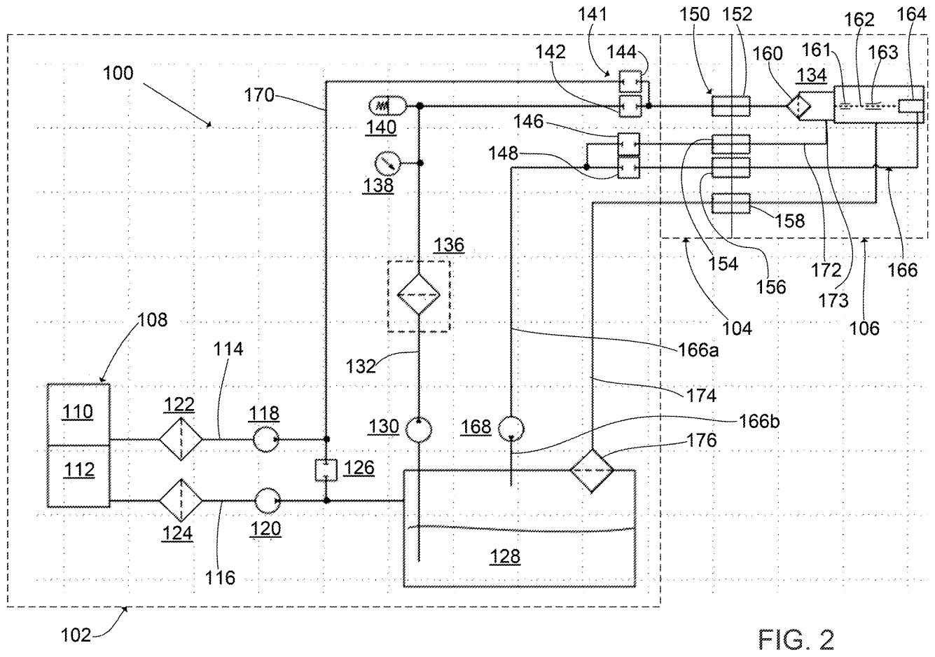

FIG. 2 is a schematic illustration of a fluid circuit of a CIJ printer in accordance with an embodiment of the invention;

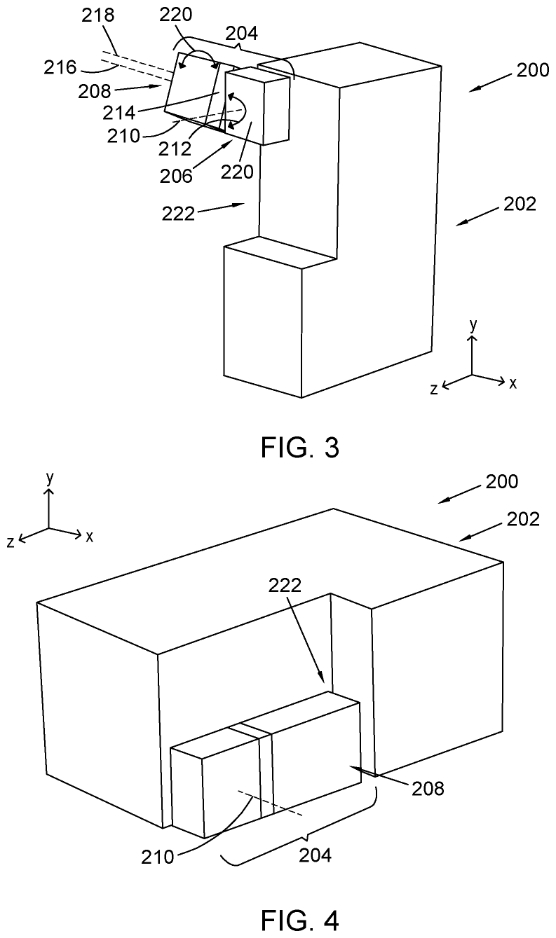

FIG. 3 is a perspective view of a CIJ printer, in a deployed configuration, in accordance with an embodiment of the invention;

FIG. 4 is a perspective view of the CIJ printer shown in FIG. 3, in a stowed configuration;

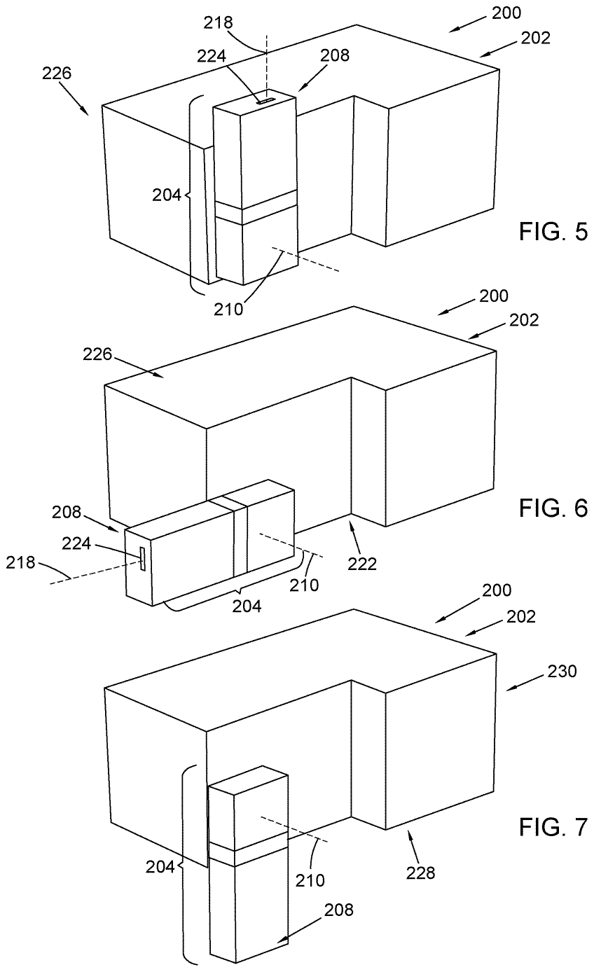

FIGS. 5 to 7 are perspective views of the CIJ printer of FIGS. 3 and 4 in three different deployed configurations;

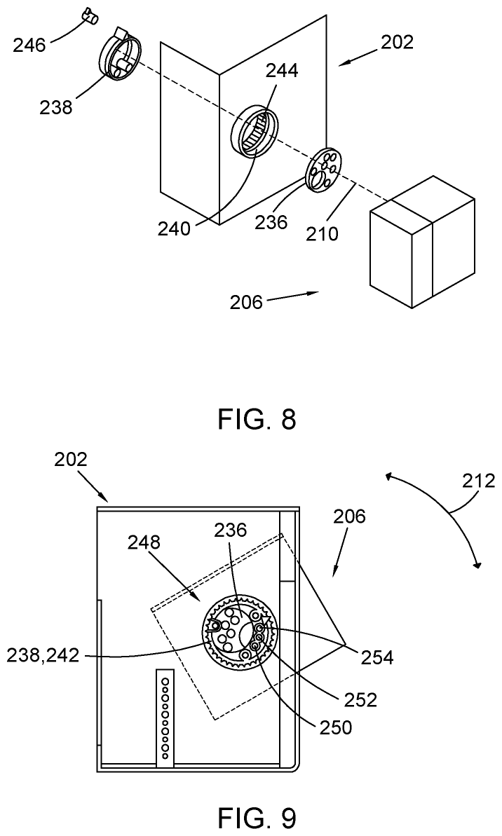

FIG. 8 is an exploded view of components of the CIJ printer of FIGS. 3 to 7 which form a rotatable coupling;

FIG. 9 is a perspective view of the components of FIG. 8 when assembled;

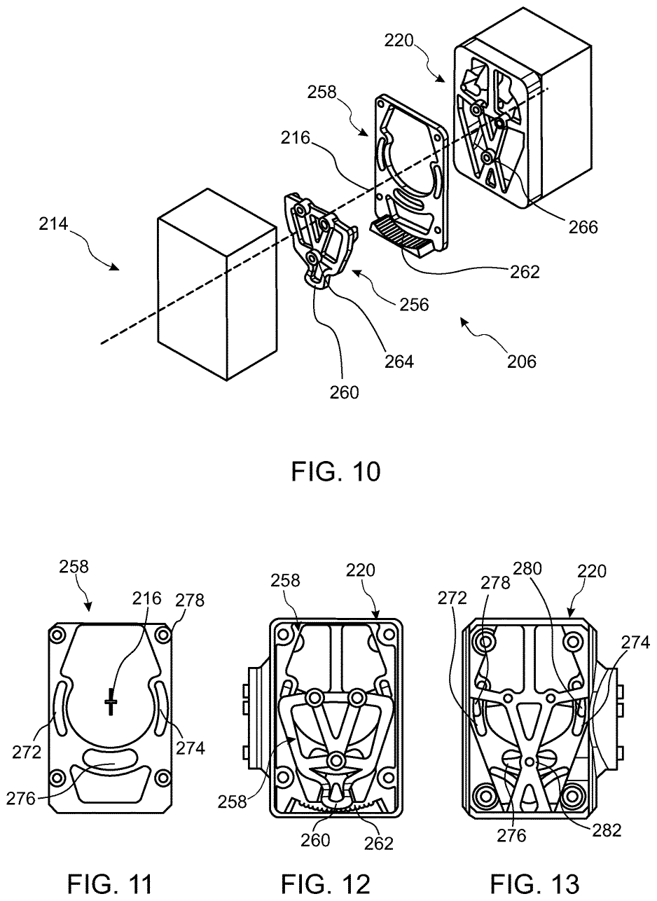

FIG. 10 is an exploded view of components of the CIJ printer of FIGS. 3 to 7 which provide tilting functionality;

FIG. 11 shows an alignment plate of FIG. 10 in isolation;

FIG. 12 shows a subassembly of the assembled components of FIG. 10 from a first side;

FIG. 13 shows the subassembly of FIG. 12 from the opposing side;

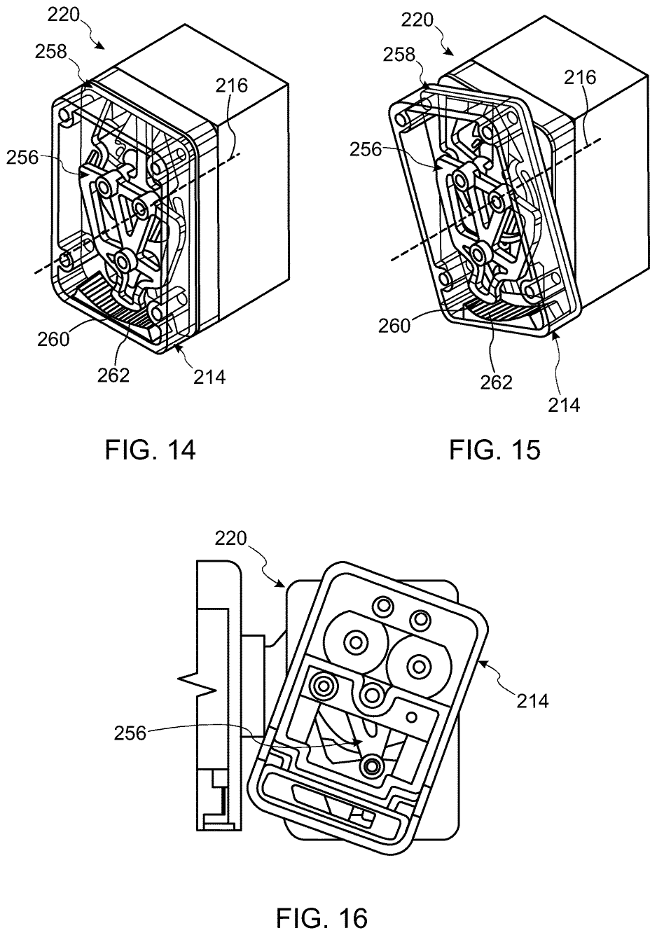

FIG. 14 is a perspective cutaway view of the subassembly of FIGS. 12 and 13 with a tiltable portion aligned with a non-tiltable portion about a tilt axis;

FIG. 15 is a perspective cutaway view of the subassembly of FIG. 15 with the tiltable portion tilted relative to the non-tiltable portion about the tilt axis;

FIG. 16 is an end cutaway view of the subassembly of FIGS. 12 to 15 with the tiltable portion tilted relative to the non-tiltable portion about the tilt axis;

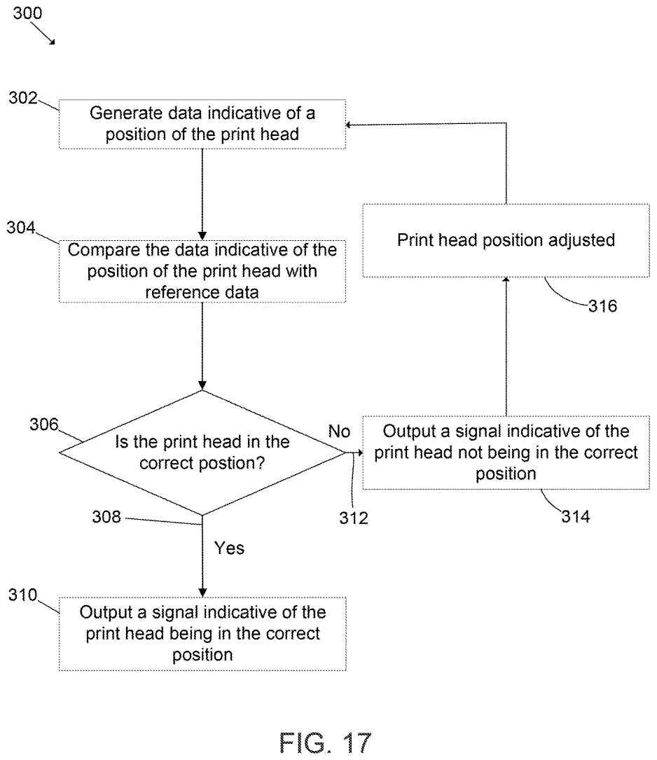

FIG. 17 is a schematic illustration of a method of controlling a CIJ printer in accordance with an embodiment of the invention; and

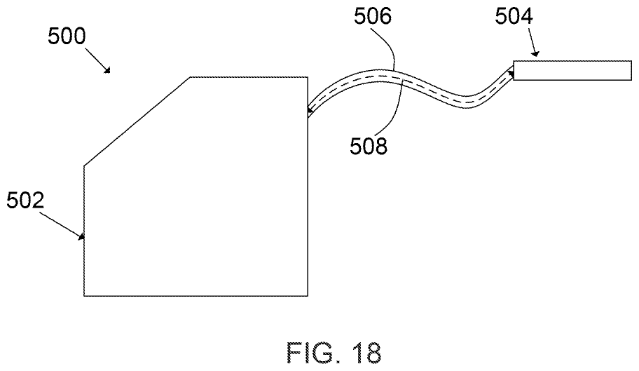

FIG. 18 is a schematic illustration of a CIJ printer in accordance with an embodiment of the invention.

FIG. 1 schematically illustrates a continuous inkjet (CIJ) printer 1 according to an embodiment of the invention. The printer 1 comprises a printer body 2 and a print head 3. The print head 3 is pivotally connected to the printer body 2 via a rotatable coupling 4. The printer body 2 houses an ink system 5 and a printer controller 6. The printer body 2 also has an interface 7 (e.g. a display, keypad, and/or touch screen) for use by an operator.

The print head 3 is arranged to print on a substrate provided adjacent to the print head 3. The printer 1 comprises two connectors (e.g. male connectors) for engagement with respective fluid compartments of a cartridge or cartridges, optionally via a corresponding connector (e.g. female connector) of the compartment or cartridge. In particular, the printer 1 comprises a connector for engagement with an ink compartment 8 and a connector for engagement with a solvent compartment 10. The connections typically each comprise a fluid port arranged to connect to a fluid pathway within the printer 1 to allow fluid to flow between the compartments 8, 10 and other parts of the inkjet printer 1, such as the ink system 5 and the print head 3.

In operation, ink from the ink compartment 8 and solvent from the solvent compartment 10 can be mixed within the ink system 5 to generate printing ink of a desired viscosity that is suitable for use in printing. This ink is supplied to the print head 3 and unused ink is returned from the print head 3 to the ink system 5. When unused ink is returned to the ink system 5 from the print head 3, air may be drawn in with ink from a gutter of the print head 3. The air may then become saturated with solvent in the gutter line.

In operation, ink is delivered under pressure from the ink system 5 to the print head 3 and recycled back via flexible tubes which are bundled together with other fluid tubes and electrical wires (not shown). In order to maintain correct consistency of the ink, the ink system 5 may be operable to mix ink removed from the ink compartment 8 with solvent removed from the solvent compartment 10 and to mix them together to obtain an ink having the correct viscosity and/or density for a particular printing application.

The printer 1 further comprises a first position detector 11. The first position detector 11 is disposed in the printer body 2. The first position detector 11 is configured to detect the position (e.g. orientation) of the printer body 2 (e.g. vertical, horizontal etc.) The printer 1 further comprises a second position detector 12. The second position detector 12 is disposed in the print head 3. The second position detector 12 is configured to detect the position (e.g. orientation) of the print head 3 (e.g. the rotational position thereof).

Each of the first and second position detectors 11, 12 are connected to the printer controller 6. The printer controller 6 is also connected to the interface 7.

FIG. 2 is a schematic illustration of a fluid circuit 100. The fluid circuit 100 forms part of a CIJ printer in accordance with embodiments of the invention.

Dashed lines are used in FIG. 2 to indicate the boundaries of various components, shown in the fluid circuit 100, which form part of a CIJ printer (e.g. the printer 1 of FIG. 1) in accordance with embodiments of the invention. A first box 102 indicates components housed within a printer body (e.g. printer body 2 of FIG. 1). A second box 104 indicates components mounted in a print head support arm. A third box 106 indicates components mounted within the print head (e.g. print head 3 of FIG. 1). The combination of second and third boxes 104, 106 may be said to define a print arm. The components bound by at least the first box 102 may be described as an ink system.

In some embodiments, and as will be described in detail below, the print head support arm (e.g. components bound by 104) may be rotatably connected to the printer body (e.g. components bound by 102). The print head (e.g. components bound by 106) may be removably connected to the print head support arm. The print head may be tiltable with respect to the print head support arm. In other embodiments, the print head support arm may be omitted, and the print head be coupled to the printer body via an umbilical.

In the illustrated embodiment, the fluid circuit 100 comprises a single, replaceable cartridge 108. The cartridge 108 contains both solvent and ink used in the printing process. Unlike prior art arrangements, the fluid circuit 100 comprises the single cartridge 108 as opposed to separate cartridges for solvent and ink respectively. The cartridge 108 is split into a plurality of different compartments (e.g. may have only two compartments). The cartridge 108 in the illustrated embodiment is split into a pair of compartments: a solvent compartment 110 and an ink compartment 112. As suggested by the names, the individual compartments contain (only) solvent and (only) ink respectively. Compartments 110, 112 may otherwise be referred to as tanks. The single cartridge 108 is an optional feature of the present invention and, in other embodiments, a plurality of cartridges may otherwise be incorporated. However, incorporation of a single cartridge is beneficial for reasons of reduced waste and a reduced maintenance requirement.

Downstream of the cartridge 108, a solvent supply line 114 and ink supply line 116 are provided. The solvent and ink supply lines 114, 116 are separate conduits which can be selectively placed in fluid communication with one another if desired. Each of the solvent and ink supply lines 114, 116 connects the cartridge 108, specifically the solvent and ink compartments 110, 112 thereof, to a solvent refill pump 118 and an ink refill pump 120. Each of the solvent refill pump 118 and ink refill pump 120 can be used to selectively pump solvent and ink from the solvent and ink compartments 110, 112 respectively of the cartridge 108. The solvent and ink refill pumps 118, 120 are diaphragm pumps in the illustrated embodiment, but other varieties of pump could otherwise be used.

Each of the solvent and ink compartments 110, 112 of the cartridge 108 are removably connectable to respective solvent and ink supply lines 114, 116. This allows for periodic replacement of the cartridge 108 when either or both of the ink and solvent levels in the compartments 110, 112 drops below a threshold level (e.g. when completely empty). Each of the solvent and ink supply lines 114, 116 may comprise a probe (e.g. a male connector) which is configured to engage a corresponding port (e.g. female connector) in fluid communication with a respective solvent and ink compartment 110, 112. Before being introduced to the ink system, the ports on the cartridge 108 may be sealed. Upon introduction, or insertion, to the ink system, the seals may be pierced by the corresponding probes, thus placing the compartments 110, 112 in fluid communication with the solvent and ink supply lines 114, 116 respectively. It will be appreciated that a number of alternative options for placing the compartments 110, 112 in fluid communication with the solvent and ink supply lines 114, 116 exist (e.g. on-off valves etc.).

A solvent filter 122 interposes the cartridge 108 and the solvent refill pump 118 along the solvent supply line 114. Similarly, an ink filter 124 interposes the cartridge 108 and the ink refill pump 120 along the ink supply line 116. The purpose of the filters 122, 124 is to remove any small particulates from the solvent and ink before they pass downstream of the solvent and ink refill pumps 118, 120. Examples of such particulates include debris (e.g. rubber debris) from seals (e.g. needle septum seals) resulting from the introduction/insertion of the cartridge 108. The filters 122, 124 may be around 8 micron filters (e.g. mesh size).

A mixing valve 126 is provided between the solvent and ink supply lines 114, 116. The mixing valve 126 selectively places the solvent and ink supply lines 114, 116 in fluid communication with one another. This is primarily of use for directly providing solvent, from the solvent compartment 110, to a mixer tank 128 (which may be referred to as a mixing tank). When it is desired to add solvent from the solvent compartment 110 to the mixer tank 128 (e.g. ‘top up’ the mixer tank 128 with solvent), a flush valve 144 (disposed along flush line 170) is closed, mixing valve 126 is opened, and solvent refill pump 118 is activated. Closure of the flush valve 144 prevents solvent flowing past the flush valve 144. The ink refill pump 120 acts as a valve, when not pumping (e.g. as is the case when solvent is added to the mixer tank 128), and substantially prevents solvent travelling beyond the ink refill pump 120 towards the ink compartment 112 along ink supply line 116. Under action of the solvent refill pump 118, solvent is thus added to the mixer tank 128. For completeness, when it is desired to add ink from the ink compartment 112 to the mixer tank 128, mixing valve 126 is closed and ink refill pump 120 is activated. Under action of the ink refill pump 120, ink is thus added to the mixer tank 128 (along ink supply line 116).

It is in the mixer tank 128, which may be referred to as a storage tank or reservoir, that ink and solvent are mixed together. For example: when required, more solvent can be added to reduce the viscosity of the solvent-ink mixture in the mixer tank 128. From the fluid circuit 100 shown in FIG. 2 it will be appreciated that the solvent and ink refill pumps 118, 120 can be used to pump, or drive, solvent and ink respectively from the solvent and ink compartments 110, 112 of the cartridge 108 to the mixer tank 128.

Turning now to describe a main circuit of the fluid circuit 100, downstream of the mixer tank 128 an ink pump 130 is provided. The ink pump 130 is provided along a main supply line 132 which extends from the mixer tank 128 to a nozzle 134. The nozzle 134 may otherwise be described as an aperture of a droplet generator. The ink pump 130 is used to pump a mixture of ink and solvent from the mixer tank 128 to the nozzle 134. Downstream of the ink pump 130 is a filter module 136. The filter module 136 is replaceable when required. In the illustrated embodiment the filter module 136 has a filtration size of around 15 microns, but it will be appreciated that this may vary in other arrangements. The main supply line 132 is an example of one of a plurality of fluid conduits, which may have a length of no more than 1 metre, which fluidly couple the print head to the ink system.

Downstream of the filter module 136, along the main supply line 132, a pressure transducer 138 and damper 140 are also provided. Continuing downstream, a feed valve 142 is provided. The feed valve 142 can selectively place the mixer tank 128 in fluid communication with the nozzle 134. The feed valve 142 is one valve of an array 141 of valves. Other valves in the array 141 include a flush valve 144, a purge valve 146 and a return valve 148. Each of these valves will be described in detail where appropriate.

Also forming part of the fluid circuit 100 is an array 150 of quick disconnect connectors. The array 150 of quick disconnect connectors are incorporated to provide for leak-free connection (and, moreso, disconnection) of the print head (e.g. housing components in the third box 106) in operation. The array 150 of quick disconnect connectors comprises first to fourth connectors 152, 154, 156, 158. The array 150 of quick disconnect connectors may be omitted in some embodiments.

Downstream of a first of the quick disconnect connectors 152 is a nozzle filter 160, which may be referred to as a last-chance filter. The nozzle filter 160 is provided just upstream of the nozzle 134. The nozzle filter 160 is incorporated to reduce the risk of any particulates blocking the nozzle 134. As ejected by the nozzle 134, a stream 162 of non-printing ink is shown entering a gutter 164. This is indicative of the ink which will not be applied to a substrate as part of a printing process, but will instead be recirculated back to the mixer tank 128. Whilst the above components form part of the print head, the print head also comprises a number of other components not shown in FIG. 2. For example, the print head comprises at least one electrode, e.g. a charge electrode 161 and a deflection plate 163 (also known as a deflection electrode). The deflection plate 163 may be held at a potential of around 8 kV from a reference electrode (e.g. ground plate). The deflection plate 163 and reference electrode may be referred to as a pair of deflection electrodes.

Continuing to describe the main circuit, the gutter 164 is connected to a main return line 166. The main return line 166 passes through a third 154 of the quick disconnect connectors to the return valve 148. Further downstream of the main return line 166 is a gutter pump 168. The gutter pump 168 applies constant suction in use to effectively pump a mixture of air, ink and solvent from the stream 162, via the gutter 164, back into the mixer tank 128. As will be appreciated from FIG. 2, the gutter pump 168 is disposed outside of the print head (e.g. outside of box 106). The operation of the main circuit thus concludes at this stage. The main return line 166, along with the ink main supply line 132, is an example of another of a plurality of fluid conduits which fluidly couple the print head to the ink system. The main return line 166 comprises: a first portion 166a and a second portion 166b. The first portion 166a extends from the gutter 164 to the gutter pump 168. The second portion extends from the gutter pump 168 to the mixer tank 128. The first portion 166a may be referred to as an upstream portion of the main return line 166, and the second portion 166b may be referred to as a downstream portion of the main return line 166.

One aspect of the present application that is of particular importance is the length of the first portion 166a of the main return line 166. The length of the first portion 166a of the main return line 166 is at most 1 metre, which gives rise to advantages such as reduced pumping work and heat generation. In embodiments where the first portion 166a of the main return line 166 is at most 1 metre, the restriction between the gutter 164 and the gutter pump 168 is comparatively lower (e.g. than in known arrangements) and so less flow is needed to clear the gutter 164 and the first portion 166a of the main return line 166. Solvent use is reduced as a result. In preferred embodiments the length of the first portion 166a of the main return line 166 is preferably less than around 750 mm, more preferably less than around 500 mm. In some embodiments the length of the first portion 166a of the main return line 166 is at least around 100 mm. The length of the first portion 166a is preferably between around 100 mm and around 500 mm. Another aspect of the present application which is of particular importance is that the print head is pivotally connected to a printer body by a rotatable coupling. These aspects may be combined with one another, or used in isolation of one another.

The functionality of the flush valve 144 will now be described. As will be appreciated from FIG. 2, when the mixing valve 126 is closed, such that the solvent and ink supply lines 114, 116 are not directly connected to one another, a flush line 170 provides a direct flow passage for solvent downstream of the solvent refill pump 118 to the flush valve 144 (and the nozzle 134). Flushing solvent through the nozzle 134 is particularly desirable during start-up and shut down procedures, to reduce the risk that the nozzle 134 becomes blocked. Whilst the nozzle flushing process occurs, the flush valve 146 is open and the gutter pump 168 applies suction, through a purge line 172, to draw the solvent from the nozzle 134 to the mixer tank 128. The purge line 172 is connected to the nozzle 134 via a side port 173. The gutter 164 can also be flushed with solvent in a similar manner. Whilst the gutter flushing process occurs, the mixing valve 126 is closed, the solvent refill pump 118 is activated, the flush valve 144 is open and the gutter pump 168 applies suction, through the main return line 166 (and open return valve 148), to draw the solvent from the gutter 164 to the mixer tank 128. The nozzle flushing process may utilise a higher flowrate of solvent owing to the solvent being drawn out of the side port 173 as opposed to the gutter 164 (the gutter 164 having a smaller cross-sectional area, and thus limiting the flowrate of fluid therethrough). The nozzle flushing process utilises a solvent jet, ejected from the nozzle 134, which is cleared by the gutter 164 and gutter pump 168. Advantageously, providing multiple fluid lines (e.g. the purge line 172 and the main return line 166) to the print head means that different cleaning processes can be carried out as needed. It will be appreciated that the gutter flushing process may, to at some extent, also clean the nozzle 134 given that the solvent passes through the nozzle 134.

A further line connected to the mixer tank 128 is vent line 174. The vent line 174 is connected to the mixer tank 128 via a vent filter 176. The vent line 174 passes through a fourth quick disconnect connector 158 of the array 150 of quick disconnect connectors. The vent line 174 opens out into the print head to provide a pressure release for the air drawn into the mixer tank 128 via the gutter pump 168. By venting out into the print head, the solvent losses from within the mixer tank 128 are comparatively lower than if the vent line 174 was to be vented to atmosphere. This is owing to the print head defining a generally enclosed volume, the air in which is saturated with solvent vapour.

The fluid circuit 100 provides a number of advantages over the fluid circuits known CIJ printers. Firstly, no ink heater is incorporated, which reduces the heat generated within the printer body. This is particularly advantageous given the relatively compact, low-volume nature of the printer according to embodiments of the invention (as will be described in detail below). The solvent and ink refill pumps 118, 120 are small, accurate diaphragm pumps which both pump, and measure, solvent and ink respectively. The pumps 118, 120 can therefore provide feedback (e.g. passive feedback) regarding the levels of solvent and ink use respectively. That is, the number of actuations of the pumps 118, 120 is indicative of the volume of fluid pumped across the pumps 118, 120. The presence of the ‘separate’ gutter pump 168, in combination with the ink pump 130, means that no venturi is needed to draw the ink/air/solvent mix back into the mixer tank 128 from the gutter 164 (as is typically the case in prior art fluid circuits). This results in a significant reduction of the heat generated within the printer body, at least because the ink pump 130 would otherwise have to pump up to around 100 times the volume of ink actually needed for printing in order to generate the necessary gutter suction by virtue of a venturi.

Although not shown in FIG. 2, various components of the fluid circuit 100, as well as other components of the printer more generally, are controlled by a controller (labelled 6 in FIG. 1). The controller receives signals from various sensors within the printer and is operable to provide appropriate control signals to components of the fluid circuit 100 (e.g. the solvent and ink refill pumps 118, 120, the ink pump 130, the gutter pump 168, the array 141 of valves) to control the flow of ink and solvent through the printer. The controller may be any suitable device known in the art, and typically includes at least a processor and memory.

Turning to FIG. 3, a perspective view of a printer 200 according to an embodiment of the invention is provided. The printer 200 comprises a printer body 202 and a print arm 204. The printer 200 shown in FIG. 3 generally corresponds to the schematic illustration of the printer 1 shown in FIG. 1.

The printer body 202 houses an ink system, components of which are generally bound by box 102 of FIG. 2. For example, the printer body 202 houses (with reference to FIG. 2) a cartridge 108, pumps (e.g. an ink pump 130), a mixer tank 128, and various fluid conduits extending therebetween (e.g. main supply line 132 and main return line 166). Although not shown in FIG. 3, the printer body 202 also houses a controller. The controller receives signals from various sensors within the printer 200 and is operable to provide appropriate control signals to components of the printer 200 to control the flow of ink and solvent through the printer 200.

The print arm 204 comprises a print head support arm 206 and a print head 208. The print head support arm 206 is pivotally connected to the printer body 202 about a rotatable coupling (not visible in FIG. 3). The print head support arm 206, and the print arm 204 more generally, are therefore rotatable about a print head rotation axis 210 with respect to the printer body 202. Arrow 212 indicates the directions of rotation in which the print arm 204 can rotate.

Advantageously, the print head 208 being pivotally connected to the printer body 202 means that the rotational position of the print head 208 can be adjusted, relative to the printer body 202, to a plurality of different rotational configurations. This provides greater flexibility of the position of the print head 208 relative to an external substrate, onto which printing occurs. The print head 208 is preferably rotatable through a range of around 270° about the print head rotation axis 210. The extent of print head 208 rotation may be limited to around 270° about the print head rotation axis 210 to avoid electrical/fluid conduits, which extend between the printer body 202 and the print head 208, getting damaged. However, in other embodiments the print head 208 may be rotatable about the print head rotation axis 210 by more than around 270°.

The print head rotation axis 210 is preferably horizontal during printing operations. A vertical position at which printing occurs on an external substrate can be adjusted by adjusting the rotational position of the print head 208. A horizontal position at which printing occurs is controllable by adjusting the print timing on an associated printing line.

The print head 208 is removable from the print head support arm 206. Specifically, the print head 208 may be described as being removably engageable with the print head support arm 206. The print head 208 may be removable by way of a snap-fit coupling or other detachable coupling. Specifically, as shown in FIG. 3, the print head 208 may be removable from a tiltable portion 214 of the print head support arm 206.

The tiltable portion 214 of the support arm is tiltable about a tilt axis 216. By virtue of the connection of the print head 208 to the tiltable portion 214, the print head 208 is also tiltable about the tilt axis 216. The tilt axis 216 may be described as a print head tilt axis. The tilt axis 216 is parallel to an ink ejection axis 218 defined by an ink ejection aperture (not shown in FIG. 3) of the print head 208. Arrow 220 indicates the relative direction of rotation (i.e. tilt) of the print head 208, and the tiltable portion 214 of the print head support arm 206, relative to a non-tilting portion 220 of the print head support arm 206. The print head 208 and tiltable portion 214 of the support arm 204 may be tiltable by up to around ±20° about the tilt axis 216 with respect to the non-tilting portion 220 of the print head support arm 206 (and so the printer body 202). The tilt axis 216 is preferably substantially orthogonal to the print head rotation axis 210. The print head rotation axis 210 is substantially orthogonal to the ink ejection axis 218.

Advantageously, being able to tilt the print head 208 relative to the printer body 202 can compensate for any slanting of the printed pattern that may otherwise result from the external substrate moving past the print head 208 at speed. The tiltable nature of the print head 208 thus facilitates printing onto high-speed print lines or onto sloping lines where printed characters may otherwise be distorted. However, in other embodiments the print head 208 may not tilt with respect to the printer body 202.

FIG. 3 also illustrates that the printer body 202 comprises a print head recess 222. The printer 200 can be placed in a stowed configuration in which the print arm 204 is rotated such that the print head 208, more generally the print arm 204, are received in the print head recess 222. Advantageously, this means that the overall footprint of the printer 200 is reduced when the printer 200 is in the stowed configuration. Furthermore, the print head 208 is better protected when the printer 200 is in the stowed configuration (desirable for, for example, when the printer 200 is in transit). For completeness, the printer 200 as shown in FIG. 3 is in a deployed (i.e. print-ready) configuration in which the print head 208 is not received within the print head recess 222. In the deployed configuration (of which there may be a number of different examples of deployed configuration), the print head 208 generally faces away from the printer body 202 such that the ink ejection axis 218 can be angled towards an external substrate on which printing is to be carried out.

Turning to FIG. 4, a perspective view of the printer 200 in an alternative configuration is provided. In FIG. 4 the printer 200 is shown in a stowed configuration in which the print head 208, and print arm 204 more generally, is received within the print head recess 222 of the printer body 202. The print arm 204, and so print head 208, are nested within the print head recess 222 of the printer body 202 in FIG. 4. The print head 208, and print arm 204, may therefore be described as nestable within the print head recess 222. The print arm 204 being nested within the print head recess 222 may otherwise be described as the print arm 204 being entirely contained within a major footprint defined by the printer body 202 (i.e. a volume defined by the printer body 202 in the absence of the print head recess 222).

In the stowed configuration (i.e. as shown in FIG. 4), the printer 200 may be substantially box-shaped or cuboidal. Approximate dimensions of the printer 200 in the stowed configuration, and so of the box-shape, may be in the region of 0.35 m×0.2 m×0.085 m. The volume of the printer 200 may be less than approximately 0.01 m², more preferably less than around 0.006 m². The printer 200 is thus significantly more compact than existing CIJ printers.

In the stowed configuration shown in FIG. 4, the print head 208 may be substantially sealed to facilitate cleaning or other maintenance. An outer, end face of the print head 208 may contact (e.g. interfere with) a sealing surface 223 of the recess 222 to provide the seal in some embodiments. Being able to clean/maintain the print head 208, and printer 200 more generally, with the print head 208 in the stowed configuration is desirable for at least the reason that initial splatter out of the print head 208 (e.g. due to pressure differences within the ink system) can be avoided on start-up. That is to say, undesirable ink/solvent ejection from the print head 208, which otherwise risks contamination of the associated printing line, can be avoided. It will also be appreciated that the printer 200 can be powered on, and any pre-printing cycles (e.g. a cleaning cycle) run, with the print head 208 in the stowed configuration. Returning briefly to FIG. 2, incorporation of the vent line 174, through which solvent-laden air can be draw into the print head 208 from the mixer tank 128, facilitates the ‘sealed’ start-up of the printer 200. This is owing to the mixer tank 128, return line 166, vent line 174 and print head forming a closed loop of sorts, allowing for pressure balancing within the system without using ‘fresh’ external air (which, owing to not being laden with solvent, would otherwise lead to increased solvent usage).

Turning to FIGS. 5 to 7, perspective views of the print arm 204, and so print head 208, in three different rotational positions are provided.

Beginning with FIG. 5, although not described in connection with any Figures thus far, the print head 208 comprises an ink ejection aperture 224. As suggested by the name, this is an opening through which ink droplets to be printed on an external substrate are ejected. It is also the ejection aperture 224 that defines the ink ejection axis 218. In the rotational configuration shown in FIG. 5, which is a first example of a deployed configuration, the ink ejection aperture 224 faces the same direction as a first major face 226 of the printer body 202. In contrast, in FIG. 7 the ink ejection aperture (although not visible in FIG. 7) faces in the same direction as a second major face 228 of the printer body 202. The configuration of the print arm 204 shown in FIG. 5 may otherwise be described as an approximately 90° rotation from the stowed configuration shown in FIG. 4, whilst the FIG. 7 configuration may be described as an alternative and opposing 90° rotation from the stowed configuration.

Turning to FIG. 6, the ink ejection aperture 224 faces directly away from the print head recess 222 of the printer body 202 in this further of a deployed configuration. The ink ejection axis 218 is also labelled in FIG. 6, and is shown generally parallel to both first and second major surfaces 226, 228 of the printer body 202.

For the avoidance of doubt, printing can occur with the printer 200 in any of the deployed configurations shown in FIG. 5 to 7. Furthermore, printing can occur with the printer 200, specifically the printer body 202 thereof, being positioned such that either of the first or second major surfaces 226, 228 are substantially horizontal, or are substantially vertical, or any position therebetween (e.g. inclined). For example, the first or second major surfaces 226, 228 can be placed on a supporting surface. Alternatively, a face 230 of the printer 200 (which may be referred to as a base) distal the print arm 204 may be placed on a supporting surface (e.g. as shown in FIG. 3). Irrespective of the orientation of the printer body 202, the print head rotation axis 210 is preferably substantially horizontal during printing operations.

FIG. 8 is an exploded view of components of the printer 200 which form the rotatable coupling (e.g. between the printer body 202 and the print head [not shown in FIG. 8]). FIG. 8 shows part of the printer body 200, the print head support arm 206, a disc 236 and a collar 238. The print head rotation axis 210 is also schematically indicated. In the illustrated embodiment the rotatable coupling may be described as a ratcheted rotation joint.

When assembled, the disc 236 is coupled to the print head support arm 206 such that the print head support arm 206 and disc 236 are rotationally fixed relative to one another. The disc 236 is receivable by a bore 240 of the printer body 202. The collar 238 is then coupled to the disc 236. The disc 236 and collar 238 (and the print head support arm 206) are thus axially constrained within the bore 240 about the print head rotation axis 210. Teeth of the collar 238 (not visible in FIG. 8, but labelled 242 in FIG. 9) mesh with a ratchet profile 244 (e.g. grooves) of the bore 240. The disc 236 and collar 238, and so the print head support arm 206, can thus be incrementally rotated about the print head rotation axis 210 with respect to the printer body 202.

Turning to FIG. 9, a perspective view of the components of FIG. 8, when assembled, is provided. FIG. 9 therefore shows the rotatable coupling 248. FIG. 9 shows the teeth 242 of collar 238 meshing with the ratchet profile 244 of the bore 240 of the printer body 202. As mentioned above, this provides incremental rotation of the print head support arm 206 about the printer body 202 as indicated by arrow 212.

Finally, three conduits 250, 252, 254 are also shown extending through the disc 236 (and so rotatable coupling 248 more generally). These conduits extend between the printer body 202 and the print head (when the print head is installed on the print head support arm 206). A further, fourth conduit also extends between the printer body 202 and the print head, but is not shown in FIG. 9. The fourth conduit is for air/vapour.

FIG. 10 is an exploded view of components of the printer 200 which provide the tilting functionality (e.g. between a tiltable portion 214 of the print head support arm 206 and a non-tiltable portion 220 of the print head support arm 206). FIG. 10 shows the tiltable portion 214 of the print head support arm 206, the non-tiltable portion 220 of the print head support arm 206, an indexer 256 and an alignment plate 258. The tilt axis 216 is also schematically indicated.

When assembled, the indexer 256 is coupled to the non-tiltable portion 220. In the illustrated embodiment this is by way of three aligning bores (through which a fastener is receivable), for each of the indexer 256 and the non-tiltable portion 220, one of which is labelled 264 on the indexer 256 and 266 on the non-tiltable portion 220. When assembled, the alignment plate 258 is coupled to the tiltable portion 214. The indexer 256 is retained between the alignment plate 258 and the tiltable portion 214. The alignment plate 258 is retained between the indexer 256 and the non-tiltable portion 220. Relative rotation between the indexer 256 and the alignment plate 258 provides the tilting functionality about the tilt axis 216. Meshing of a projection 260 (e.g. a tooth) of the indexer 256 with a ratchet profile 262 (e.g. grooves) on the alignment plate 258 provides incremental tilting of the alignment plate 258 relative to the indexer 256, and so incremental tilting of the tiltable portion 214 relative to the non-tiltable portion 220. The tilting may occur in increments of around 2°, or around 2.5°.

FIG. 11 shows the alignment plate 258 in isolation from a side of the alignment plate 258 which is proximate the non-tiltable portion 220. First and second tracks 272, 274 are visible, which receive corresponding lugs of the indexer 256 to constrain the rotation, or tilting, of the alignment plate 258 relative to the indexer 256. A third track 276 receives a boss, in which the bore 266 is defined, therethrough. The tilt axis 216 is also schematically indicated. The tilt axis 216 is defined by the first to third tracks 272, 274, 276. One of four bores, configured to receive a fastener therethrough to couple the alignment plate 258 to the tiltable portion 214, is also labelled.

FIG. 12 shows a subassembly comprising the indexer 256, the alignment plate 258 and the non-tiltable portion 220. FIG. 12 shows the subassembly from the perspective of the tiltable portion 214. FIG. 12 also shows the projection 260 of the indexer 258 engaging the ratchet profile 262 of the alignment plate 258.

FIG. 13 shows the subassembly from the opposing side. First and second lugs 278, 280 of the indexer 258 are shown received in the first and second tracks 272, 274 respectively. Boss 282, forming part of the non-tiltable portion 220, is shown received in the third track 276.

FIG. 14 is a perspective cutaway view of the subassembly with the tiltable portion 214 aligned with the non-tiltable portion 220 about the tilt axis 216. The projection 260 of the indexer 256 engages a central portion of the ratchet profile 262. FIG. 15 is a perspective cutaway view of the subassembly with the tiltable portion 214 tilted relative to the non-tiltable portion 220 about the tilt axis 216. The projection 260 of the indexer 256 engages a non-central portion of the ratchet profile 262.

FIG. 16 is an end cutaway view of the subassembly with the tiltable portion 214 tilted relative to the non-tiltable portion 220 about the tilt axis 216.

A method of using the printer 200 may comprise positioning the printer body 202 with respect to a target print location, such as an external substrate. The method may further comprise rotating the print head 208 (e.g. optionally by way of rotating the print arm 204) about the print head rotation axis 210 to align the ink ejection aperture 224 with the target print location.

Rotating the print head 208 relative to the printer body 202 may transition the printer 200 from a stowed configuration (e.g. as shown in FIG. 4), in which the print head 208 is received in a print head recess 222, to a deployed configuration (e.g. FIGS. 3 and 5 to 7) in which the ink ejection aperture 224 faces away from the printer body 202. After printing, the print head 208 may be rotated relative to the printer body 202 to transition the printer 200 to the stowed configuration (e.g. FIG. 4) in which the print head 208 is received in the print head recess 222.

The printer 200 may comprise one or more position detectors (e.g. first and second position detectors 11, 12 shown in FIG. 1). The one or more position detectors may, for example, be configured to detect the relative orientation (e.g. rotational position and/or tilt angle) between two components of the printer 200. For example, the relative orientation of the print arm 204 (optionally the print head 208 thereof) to the printer body 202. The one or more position detectors may be, for example, configured to detect the absolute orientation of one or more components in space (e.g. which orientation the printer body 202 is in), as opposed to a relative orientation between two components. The printer body 202 and/or the print arm 204, or a subcomponent thereof (e.g. the print head 208 and/or the print head support arm 206) may comprise one or more position detectors. For example, the rotatable coupling between the printer body 202 and the print arm 204 may comprise a position detector.

The position detector may be a rotary encoder, or a sensor, capable of detecting the rotational position and transmitting a signal indicative of the (relative) rotational position. The position detector may be an accelerometer. One or more position detectors may be configured to detect, for example, whether the printer 200 is in a stowed or deployed configuration. Optionally, the one or more position detectors may be configured to detect which deployed configuration, of a plurality of different deployed configurations, the printer 200 is in. Position detectors that are configured to detect a rotational position may be referred to as a rotational position detector.

A position detector may be incorporated in one or more of the print head 208, the tiltable portion 214 of the print head support arm 206, the non-tiltable portion 220 of the support arm 206, the printer body 202, and the rotatable coupling. The position detector may be configured to detect the relative angle of tilt of the print head 208 relative to the non-tilting portion 220 of the print head support arm 206. The position detector may be referred to as a tilt position detector.

One or more position detectors incorporated in the printer 200 may alternatively, or in combination, be configured to detect the orientation of the printer body 202 and so printer 200 more generally. Such position detectors may be referred to as a printer orientation detector. For example, the one or more position detectors may be configured to detect whether, with reference to FIG. 6, the printer 200 is supported by the first major surface 226, the second major surface 228 or the face 230. The one or more position detectors may therefore indicate whether the printer 200 is in a horizontal configuration (e.g. as shown in FIGS. 5 to 7) or in a vertical configuration (e.g. as shown in FIG. 3). The one or more printer orientation detectors may be an accelerometer. In combination with a rotational position detector which indicates the rotational position of the print arm 204, and so print head 208, relative to the printer body 202, the combination of position detectors (e.g. at least one rotational position detector and at least one printer orientation detector) can therefore be configured to indicate which deployed configuration the printer 200 is in (e.g. be able to differentiate between the deployed configurations shown in FIGS. 5 to 7).

An accelerometer may be incorporated to provide a global baseline of the position of the printer 200 in space. A rotary encoder, for example, may be used, to detect the relative position of the print arm 204, and so print head 208, relative to the printer body 202 (or of any other component which is rotatable relative to another component about an axis). The combination of the accelerometer and rotary encoder may therefore be used to determine the position of the print arm 204, and so print head 208. Alternatively, an accelerometer may be incorporated in any component for which sensing the position is of interest (e.g. one or more of the print head 208, the tiltable portion 214 of the print head support arm 206, the non-tiltable portion 220 of the support arm 206, the printer body 202, and the rotatable coupling).

One or more of the position detectors mentioned above may form part of a method 300 of controlling the printer 200 as schematically indicated by FIG. 17. In a first step 302 of the method, data is generated indicative of a position of the print head 208. The data in step 302 relates to a current position of the print head 208. The position of the print head 208 may be indicated by a signal outputted by a position sensor such as a rotary encoder or accelerometer. As described above, the position may be a relative position of the print head 208 to the printer body 202 (e.g. using a rotary encoder), or may be an absolute position of the print head 208 in space (e.g. using an accelerometer).

The data indicating the position of the print head 208 is then compared to reference data indicating a reference position of the print head 208 at step 304. The reference position of step 304 may be the rotational position of the print head 208 in a last, or a preset, printing configuration. The reference data may therefore be indicative of the position of the print head when last used for printing, or a position of the printhead for printing on a given external substrate. The reference data may be indicative of a position of the print head 208 before the printer 200 is placed in the stowed configuration so that the print head 208 can be cleaned.

At step 306 the data indicating the position of the print head 208 is compared to the reference data indicative of the reference position of the print head 208. Described another way, a comparison is made as to whether the print head 208 is in the correct position (the correct position being determined based upon the reference data).

If the print head 208 is in the correct position, as indicated by line 308, a signal is outputted, at step 310, to indicate that the print head is in the correct position. The output may be communicated to an operator by a user interface (e.g. a graphical user interface). With the print head 208 in the correct position, printing can begin. Put another way, step 310 may correspond to the printer being in a print-ready configuration. Step 310 may indicate that the print head 208 has been returned to the previous, correct, position before the print head 208 was cleaned.

If the print head 208 is not in the correct position, as indicated by line 312, a signal is outputted, at step 314, to indicate that the print head 208 is not in the correct position. Described another way, the output signal is indicative of a difference between the position and reference position of the print head 208. Examples of the print head 208 not being in the correct configuration include the print head 208 being in the stowed configuration, instead of a deployed configuration, and in the wrong deployed configuration (e.g. having the configuration shown in FIG. 5, as opposed to the configuration shown in FIG. 6). Step 314 may correspond to the printer not being in a print-ready configuration. Step 314 also preferably indicates, to a user, the adjustment(s) needed to place the print head 208 in the correct position. For example, at step 314 an operator may be informed, by way of a user interface (for example), that the print head 208 need be rotated in a particular direction to transition the print head 208 towards a print-ready configuration.

At step 316, an operator adjusts the print head 208 in response to step 314 outputting a signal that the print head 208 is not in the correct position. For example, the operator may rotate the print head 208 in a first rotational direction relative to the printer body 202. The adjustments made in step 316 are preferably informed by the signal outputted at step 314. For example, step 314 may indicate, to an operator, that the print head 208 should be rotated in a first rotational direction towards the correct position. Accordingly, an operator manually rotates the print head 208 in the first rotational direction as suggested by the output. Step 314 may therefore be described as guiding an operator to adjust the print head 208 as needed.

After step 316, the method returns to step 302 in which data indicating the position of the print head 208 is generated. The method 300 thus cycles, in an iterative manner, until the print head 208 is placed in the correct position and the printer 200 is thus in a print-ready configuration.

The method 300 may be described as a method of returning a printer 200 to a pre-cleaning configuration. The method 300 is advantageous because the printer 200 can effectively recall a previous printing configuration, after the printer 200 has been cleaned (and so the print head 208 adjusted relative to the printer body 202), so an operator can readily return the printer 200 to the printing configuration.

It will be appreciated that the reference data of step 304 may be adjusted by an operator in use. For example, an operator may manually set a correct printing position of the print head, thus generating corresponding reference data.

The print head 208 being rotatably connected to the printer body 202 is advantageous for a number of reasons. Firstly, the print head 208, and associated ink ejection aperture and ink ejection axis, are adjustable relative to the printer body 202 so that printing occurs at the correct location of an external substrate. Furthermore, a print head support (e.g. bracket) which is separate to a corresponding support for the printer body can be eliminated whilst still providing a convenient adjustment of the print head 208 relative to the printer body 202.

A further advantage of the print head 208 being pivotally connected to the printer body 202 is that fluid conduits (e.g. the main supply line 132 and main return line 166, as shown in FIG. 2) that fluidly couple the print head 208 to the ink system can be made comparatively shorter than in prior art arrangements.

As mentioned previously, in prior art arrangements the print head is typically connected to a printer body via an umbilical that is at least around 2 m, and can be up to around 8 m in length, to allow the printer body to be distanced from the print head. However, a disadvantage of these known arrangements is that the lengthy umbilical, and so fluid conduits which extend therethrough, places a significant strain on the pumps in both driving ink and/or solvent to the print head, and returning unprinted ink via the return line (e.g. drawings/sucking a mixture of unprinted ink, air and solvent from the gutter back into the mixer tank). A relatively high airflow is required, through the fluid conduits, owing to the length of the conduits, to ensure all ink is returned from the gutter and that no ink remains in the fluid conduits from the gutter. Furthermore, a comparatively high volume of ink is contained within the ink supply line at any one time, and therefore a comparatively high volume of ink has to be flushed through the ink supply line during flushing processes (e.g. priming at printer start-up, or after printing).

In preferred embodiments, (with reference to FIG. 2) the length of the first portion 166a of the main return line 166 is at most 1 metre. The pressure drop between the gutter 164 and the gutter pump 168 is comparatively lower (e.g. than in known arrangements) and so less flow is needed to clear the gutter 164 and the first portion 166a of the main return line 166. Solvent use is reduced as a result.

By limiting the length of the fluid conduits, which fluidly couple the print head to the ink system, to no more than around 1 metre in length in preferred embodiments: i) the volume of ink contained in the main supply line is reduced, reducing the volume of ink which need be flushed during flushing cycles (e.g. priming the printer at start-up); and ii) the pumping work required from the pump(s) is reduced, resulting in reduced heat generation in the system and a reduction in the size of various components in the system (e.g. the pump(s)) and the overall printer itself).

In preferred embodiments, the combined volume of the portions of line, including the nozzle 134, which extend between the feed valve 142 and the nozzle 134, and the side port 173 and the purge valve 146, is no greater than around 4 millilitres. The total volume of these portions of lines may be referred to as a flush volume, owing to that volume of line needing to be flushed with solvent when printing stops (e.g. when the jet of ink/solvent mixture through the main supply line 132 is stopped). By limiting the flush volume, flushing uses a lower volume of solvent. Flushing can therefore be carried out faster, and using less solvent, than would otherwise be the case.

Turning to FIG. 18, a schematic illustration of a printer 500 according to another embodiment is provided. The printer 500 comprises a printer body 502, which houses an ink system sharing many features in common with the features shown in FIG. 2. The printer 500 further comprises a print head 504 which is coupled to the printer body 502 via an umbilical 506.

Although not visible in FIG. 18, a number of fluid conduits fluidly couple the print head 504 to the ink system housed within the printer body 502. The fluid conduits include the main supply line 132 and the main return line 166 as shown in FIG. 2. These fluid conduits (i.e. at least the main supply line 132 and main return line 166) extend along an entire extent of the umbilical 506, and preferably extend beyond an entire extent of the umbilical 506 (i.e. so as to reach, or extend between, components within the print head 504 and within the printer body 502).

Of particular importance (with reference to FIG. 2) is the length of the first portion 166a of the main return line 166. The length of the first portion 166a of the main return line 166 is at most 1 metre, which gives rise to advantages such as reduced pumping work and heat generation, and reduced air flow which reduces solvent losses from the ink system. The pressure drop between the gutter 164 and the gutter pump 168 is comparatively lower (e.g. than in known arrangements, e.g. having comparatively longer umbilicals) and so less flow is needed to clear the gutter 164 and the first portion 166a of the main return line 166. Solvent use is reduced as a result. In preferred embodiments the length of the first portion 166a of the main return line 166 is preferably less than around 750 mm, more preferably less than around 500 mm. In some embodiments the length of the first portion 166a of the main return line 166 is at least around 100 mm. The length of the first portion 166a is preferably between around 100 mm and around 500 mm.

In preferred embodiments, the plurality of fluid conduits which fluidly couple the print head 504 to the ink system have a length of no more than 1 metre. This provides a number of advantages, some of which are set out above in connection with the printer 200, including: i) the volume of ink contained in the main supply line is reduced, reducing the volume of ink which need be flushed during flushing cycles (e.g. priming the printer at start-up); and ii) the pumping work required from the pump(s) is reduced, resulting in reduced heat generation in the system and a reduction in the size of various components in the system (e.g. the pump(s)) and the overall printer itself). The overall size of the printer 500 is also reduced in comparison to prior art arrangements in which the umbilical may be, for example, up to around 8 m in length.

As mentioned above, the printer body 502 houses an ink system that incorporates many of the features shown in FIG. 2. However, a few distinctions are provided below. Firstly, given that the print head 504 is coupled to the printer body 502 via the umbilical 506 only, the array 150 of quick disconnect connectors as shown in FIG. 2 are omitted from the fluid circuit. Furthermore, whereas the components bound by box 104 in FIG. 2 are indicative of the components which would be provided within the print head support arm 206 for the embodiment shown in FIG. 3, in the present embodiment there is no such print head support arm. As such, all of the components, less the array 150 as explained above, bound by boxes 104 and 106 may actually be provided within the print head 504. Other than for these distinctions, all of the description provided in connection with the fluid circuit 100 shown in FIG. 2 is also applicable to the present embodiment. Furthermore, although the printer 500 shown in FIG. 18 comprises a print head 504 coupled to the printer body 502 only by the umbilical 506, in other embodiments a rotatable coupling, like that shown in FIG. 1, could be incorporated in combination with the umbilical 506.

In preferred embodiments, a length (i.e. extent) 508 of the umbilical 506 is at most 1 metre. In preferred embodiments, a flush volume of the printer 500 is no more than 4 ml.

In preferred embodiments, the length of the umbilical 506 is at least around 100 mm. Advantageously, this means the printer body 502 can be distanced from the print head 504, with the print head 504 being located proximate a printing line. Described another way, an umbilical at least around 100 mm long has been found to provide sufficient adjustability, of the print head 504 relative to the printer body 502, in most circumstances.

1-21. (canceled)

22. A continuous inkjet printer for printing onto an external substrate that moves past the continuous inkjet printer, the continuous inkjet printer comprising:
a print head, the print head comprising:
a nozzle for generating and ejecting a stream of ink droplets for printing;
at least one electrode for guiding the stream of ink droplets; and
a gutter for receiving droplets of ink which are not used for printing; and
an ink system for storing ink and supplying ink to the print head; and
a printer body which houses the ink system;
wherein the print head is pivotally connected to the printer body by a rotatable coupling, the rotatable coupling being configured to permit the print head to rotate relative to the printer body about a print head rotation axis.

23. The continuous inkjet printer according to claim 22, wherein the print head has a deployed configuration for printing, and a stowed configuration for storage.

24. The continuous inkjet printer according to claim 22, wherein the print head comprises an ink ejection aperture, wherein ink droplets that are not captured by the gutter are ejected through the ink ejection aperture.

25. The continuous inkjet printer according to claim 23, wherein in the stowed configuration the print head is orientable such that the ink ejection aperture faces towards the printer body.

26. The continuous inkjet printer according to claim 23, wherein in the deployed configuration the print head is orientable such that the ink ejection aperture faces away from the printer body.

27. The continuous inkjet printer according to claim 23, wherein the printer body comprises a print head recess for receiving the print head in the stowed configuration.

28. The continuous inkjet printer according to claim 22, wherein the print head is connected to a print head support arm, the print head support arm being pivotally coupled to the printer body.

29. The continuous inkjet printer according to claim 28, wherein the print head is removable from the print head support arm.

30. The continuous inkjet printer according to claim 22, further comprising a position detector, wherein the rotatable coupling comprises the position detector.

31. (canceled)

32. The continuous inkjet printer according to claim 22, wherein the print head is rotatable though around 270 degrees about the print head rotation axis.

33. (canceled)

34. The continuous inkjet printer according to claim 22, wherein the print head is tiltable about a print head tilt axis, the print head tilt axis being substantially orthogonal to the print head rotation axis.

35. (canceled)

36. The continuous inkjet printer according to claim 34, wherein the print head is tiltable by around +/−20 degrees.

37. The continuous inkjet printer according to claim 22, wherein the print head rotation axis is substantially horizontal during printing operations.

38. The continuous inkjet printer according to claim 36, wherein the print head is fluidly coupled to the ink system via a plurality of fluid conduits, the plurality of fluid conduits comprising a main return line; and
a portion of the main return line which extends between the gutter and a gutter pump has a length of no more than 1 meter.

39. The continuous inkjet printer according to claim 38, wherein a flush volume of the printer is no more than 4 milliliters (ml).

40. A method of using a continuous inkjet printer comprising:
positioning a printer body with respect to a target print location; and
rotating a print head relative to the printer body, about a print head rotation axis, to align an ink ejection aperture of the print head with the target print location.

41. The method of using the continuous inkjet printer according to claim 40, wherein rotating the print head relative to the printer body transitions the printer from a stowed configuration, in which the print head is received in a print head recess, to a deployed configuration in which the ink ejection aperture faces away from the printer body.

42. The method of using the continuous inkjet printer according to claim 41, wherein, after printing, the print head is rotated relative to the printer body to transition the printer to the stowed configuration in which the print head is received in the print head recess.

43. A method of controlling a continuous inkjet printer comprising:
generating data, using a position detector, indicating a position of a print head;
comparing the data indicating the position of the print head with reference data indicating a reference position of the print head; and
generating an output indicative of a difference between the position and the reference position.

44. The method of claim 43, further comprising:
adjusting a position of the print head, based upon the output; and
generating new data, using the position detector, indicating an adjusted position of the print head;
comparing the data indicating the adjusted position of the print head with reference data indicating the reference position of the print head; and
generating an output indicative of a difference between the position and the reference position.
